(19) United States
(12) Patent Application Publication
(10) Pub. No.: US 2004/0227871 A1
(43) Pub. Date: Nov. 18, 2004

(54) Back light module and liquid crystal display comprising the same

(76) Inventors: Chih-Kang Wu, Taoyuan (TW); Hui-Kai Chou, Taipei City (TW)

Correspondence Address: J.C. Patents, Inc., Suite 250, 4 Venture, Irvine, CA, 92618, US

(21) Appl. No.: 10/810,206

(22) Filed: Mar. 25, 2004

(30) Foreign Application Priority Data
May 12, 2003 (TW) 92112795

(51) Int. Cl. G02F 1/1335

(52) U.S. Cl. 349/64

(57) ABSTRACT

A back light module and a LCD comprising the same are provided. The back light module includes a frame, a reflector, at least a light source, a diffusion plate, and a plurality of optical films. The reflector is disposed on the bottom of the frame, and the light source is disposed over the reflector and also in the frame. The diffusion plate is disposed on the frame, and also over the light source, and its thickness is between 4.1 mm and 15 mm. The optical films are disposed on the diffusion plate. Since the thickness of the diffusion plate in the back light module is thicker, the issues of the deformation of the diffusion plate occurring in the conventional large size LCD can be resolved.

### CROSS-REFERENCE TO RELATED APPLICATION

This application claims the priority benefit of Taiwan application serial no. 92112795, filed on May 12, 2003.

### BACKGROUND OF THE INVENTION

1. Field of the Invention

The present invention relates to a back light module and a liquid crystal display (LCD), and more particularly, to a back light module and a LCD that can avoid the warp and deformation of the diffusion plate.

2. Description of the Related Art

In order to adapt with the modem life pace, the size of the video or image apparatus is getting lighter and thinner now. Although the conventional cathode ray tube (CRT) display still has its advantage; however, it is disadvantageous in its big size and the radiation emitted by the CRT display that hurts the viewer's eyes. Therefore, the flat panel display, such as the liquid crystal display (LCD), the organic liquid crystal display (OLED), or the plasma display panel (PDP) that are developed with the photoelectric technique and the semiconductor fabricating technique, has become the mainstream of the display product.

Following the descriptions above, based on the style of the light source it uses, the LCD is roughly classified as the reflective LCD, the transmissive LCD, and the transreflective LCD. For example, the transmissive LCD or the transreflective LCD mainly comprises a liquid crystal panel and a back light module, wherein the liquid crystal panel comprises two transparent plates and a liquid crystal layer disposed in between these two transparent plates. The back light module provides a plane light source required by the liquid crystal panel to achieve the display effect.

The LCD has been widely applied in the small size panel such as the mobile phone or the personal digital assistant (PDA). Nowadays, the LCD is gradually developed to a trend towards the larger size. However, some manufacturing process issues are still exited in manufacturing the large size panel. For the diffusion panel in the back light module, the thickness of the diffusion panel for adjusting the light source in the conventional manufacturing process is generally less than 4 cm. However, when the size of the LCD is getting bigger, the size of the diffusion panel also gets correspondingly bigger, thus the diffusion panel that is too thin in the large size display panel is easily warped and metamorphosed or deformed due to its insufficient stiffness, and the optical characteristic of the back light module is further adversely affected by it.

Although the issue of the warp and deformation of the diffusion panel mentioned above can be resolved by disposing a 2˜4 mm acrylic resin panel under the diffusion panel, however, doing so will complicate the original manufacturing process increasing the manufacturing time and thereby decreasing the throughput and increasing the overall manufacturing cost.

### SUMMARY OF THE INVENTION

In the light of the above problems, it is a primary object of the present invention to solve these problems mentioned above and other defects of the prior art.

It is a further object of the present invention to provide a novel back light module for a larger size LCD panel.

It is a further object of the present invention to provide a novel back light module that can be manufactured using a more simplified process with the view of not adversely impacting the throughput and also for reducing the manufacturing cost. The back light module thus produced will have good optical characteristics. Therefore manufacturing of a larger size LCD with good display characteristics can be realized.

It is a further object of the present invention to provide a thicker diffusion plate for a back light module that is capable of resisting the phenomenon of wrap and deformation as described in the prior art above, so that requirement of any additional supporting structures for similar purpose can be effectively eliminated. Therefore requires no special process or equipment or additional process steps are required for manufacturing the back light module of the present invention. Thus the overall manufacturing cost for manufacturing the back light module using the diffusion plate can be effectively reduced.

It is a further object of the present invention to provide a LCD using the back light module of the present invention.

In accordance with the above objects and other advantages, as broadly embodied and described herein, the present invention provides a back light module and a LCD comprising the same. The back light module mainly comprises a frame, a reflector, at least a light source, a diffusion plate and a plurality of optical films. The reflector is disposed on the bottom of the frame, and the light source is disposed over the reflector and also in the frame. The diffusion plate is disposed on the frame, and also over the light source. Preferably thickness of the diffusion plate is between 4.1 mm and 15 mm. The optical films are disposed on the diffusion plate. Further, at least a supporting component is disposed in between the reflector and the diffusion plate.

Further, the present invention provides a LCD, which mainly comprises a liquid crystal panel and a back light module. The back light module mainly comprises a frame, a reflector, at least a light source, a diffusion plate, and a plurality of optical films. The reflector is disposed on the bottom of the frame, and the light source is disposed over the reflector and also in the frame. The diffusion plate is disposed on the frame, and also over the light source. Preferably, thickness of the diffusion plate is between 4.1 mm and 15 mm. The optical films are disposed on the diffusion plate. Further, at least a supporting component is disposed in between the reflector and the diffusion plate.

According to one aspect of the present invention, because a thicker diffusion panel is disposed on the frame, and therefore the thicker diffusion plate is capable of resisting the phenomenon of warp and deformation occurring in a larger size LCD panel so that a better optical characteristic of the back light module and the LCD can be maintained.

According to another aspect of the present invention, because the issue of the warp and deformation of the diffusion panel can be resolved without the need of disposing any type of supporting films (or components), and therefore requires no special or additional process steps. Thus, the present invention not only provides a simplified manufacturing process for manufacturing a diffusion plate but also a highly reliable larger size LCD panel with good optical characteristics can be realized.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic sectional view of a LCD according to a preferred embodiment of the present invention, wherein the LCD comprises a back light module and a liquid crystal panel.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

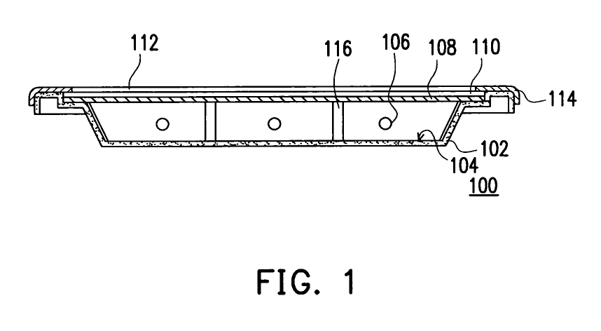

Referring to FIG. 1, the LCD of the present invention comprises a back light module 100 and a liquid crystal panel 112, wherein the back light module 100 mainly comprises a frame 102, a reflector 104, at least a light source 106, a diffusion plate 108 and a plurality of optical films 110.

The reflector 104 is disposed on the bottom of the frame 102, wherein the reflector 104 is used for reflecting the light emitted by the light source 106 along a direction not towards the display panel (not shown), so as to improve the utilization efficiency of the light source 106. Further, the reflector 104 is made by performing a rough surface process on the internal surface of a plate such as a white coating plate or a resin film, and a special surface process for forming an aluminum metal like finish, so as to improve the reflection efficiency of the reflector 104 and thereby improve the brightness of the reflecting light source.

The light source 106 is disposed over the reflector 104 and also in the frame 102. Wherein the light source 106 is for example, a tube, a bulb, a light emitting diode (LED) light source, or a fluorescent light source, and the fluorescent light source is for example, a linear tube, a U-type tube, or a planar fluorescent light. Furthermore, the light source 106 is disposed on the light source holder (not shown) on the frame 102 so as to secure the light source 106.

The diffusion plate 108 is disposed on the frame 102 and also over the light source 106. Preferably, the thickness of the diffusion plate 108 is between 4.1 mm to 15 mm. The diffusion plate 108 is made of a slim acrylic resin or a polycarbonate. When the straight light or the reflecting light of the light source 106 passes through the diffusion plate 108, the diffusion plate 108 evenly diffuses the light and generates a plane light source.

A plurality of optical films 110 is disposed on the diffusion plate 108. The diffusion plates 110 are comprised of, for example, brightness enhancement films and/or prism films. The optical films 110 are disposed in a way that the plane light source emitted by the diffusion plate 108 can fully emit into the liquid crystal panel 112, so as to improve the utilization efficiency of the light source 106.

Besides, the LCD further comprises a liquid crystal panel 112, wherein the liquid crystal panel 112 is for example, an active matrix liquid crystal panel 112 composed of a generally used TFT array film, a color filter and a liquid crystal layer. The liquid crystal panel 112 is disposed on the frame 102 that is positioned over the optical films 110. In addition, another frame 114 is further disposed to cover the edge of the liquid crystal panel 112 for securing the liquid crystal panel 112 on the frame 102. The methods for securing the liquid crystal panel 112 may include, but not limited to, the liquid crystal panel 112 between the frame 114 and the frame 102, and then securing frame 114 on the frame 102 using screws.

In the back light module 100 mentioned above, at least a supporting component 116 is further disposed in between the reflector 104 and the diffusion plate 108. The supporting component 116 is made of a transparent material so that the supporting component does not impact the light emitting of the light source 106.

Further, in order that the brightness of the plane light source generated after passing through the diffusion plate 108 to be more evenly distributed, a grating plate (not shown) may be further added in between the light source 106 and the diffusion plate 108, and accordingly, the utilization efficiency of the light source 106 is further promoted.

According to an aspect of the present invention, because a thicker diffusion plate is disposed on the frame, and therefore the thicker diffusion plate has the capability to resist the phenomenon of warp and deformation occurring in a conventional large size LCD panel so that the better optical characteristic of the back light module and the LCD can be maintained.

Further, since the issues of the warp and deformation of the diffusion plate occurring in the prior art can be effectively resolved without having to dispose any additional films or supporting structures on the frame, and therefore requires no special or additional process steps. Accordingly, the present invention not only provides a simplified manufacturing process for manufacturing does not increase the manufacturing time and overall manufacturing cost, but also realizes the possibility of manufacturing a larger size LCD panel having excellent optical characteristics.

Furthermore, it is worth mentioning that the back light module of the present invention is not necessarily limited to be applied in the LCD, instead, it is also suitable to be applied in other display that has to cooperate with the back light module.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A back light module, comprising:
a frame;
a reflector disposed on a bottom of the frame;
at least a light source disposed over the reflector;
a diffusion panel disposed on the frame and also over the light source, wherein a thickness of the diffusion plate is between 4.1 mm and 15 mm; and
a plurality of optical films disposed on the diffusion plate.

2. The back light module of claim 1, further comprising at least a supporting component disposed in between the reflector and the diffusion plate.

3. The back light module of claim 1, wherein the light source comprises either at least a tube or at least a light emitting diode (LED) light source.

4. The back light module of claim 1, wherein the optical films comprise a plurality of brightness enhancement films or a plurality of prism films or a combination thereof.

5. A liquid crystal display (LCD), comprising:
a liquid crystal display panel; and
a back light module, comprising:
a frame;
a reflector disposed on the bottom of the frame;
at least a light source disposed over the reflector;
a diffusion panel disposed on the frame and also over the light source, wherein the thickness of the diffusion plate is between 4.1 mm and 15 mm; and
a plurality of optical films disposed on the diffusion plate.

6. The back light module of claim 5, further comprising at least a supporting component disposed in between the reflector and the diffusion plate.

7. The back light module of claim 5, wherein the light source comprises either at least a tube or at least a light emitting diode (LED) light source.

8. The back light module of claim 5, wherein the optical films comprise a plurality of brightness enhancement films and a plurality of prism films or a combination thereof.
